(19) United States
(12) Patent Application Publication
(10) Pub. No.: US 2016/0042903 A1
(43) Pub. Date: Feb. 11, 2016

(54) AUTOMOTIVE CIRCUIT BREAKER INCLUDING CIRCUIT BREAKER WITH INTEGRATED SECONDARY CURRENT PROTECTION

(71) Applicants: Zachary W. Stebbings, Rehoboth, MA (US); Simon C. Kwok, Boston, MA (US); Derek H. Turner, Attleboro, MA (US)

(72) Inventors: Zachary W. Stebbings, Rehoboth, MA (US); Simon C. Kwok, Boston, MA (US); Derek H. Turner, Attleboro, MA (US)

(21) Appl. No.: 14/456,410

(22) Filed: Aug. 11, 2014

(51) Int. Cl. H01H 71/16; H01H 85/055

(52) U.S. Cl. CPC H01H 71/164; H01H 85/055; H01H 2223/002

(57) ABSTRACT

Featured is a current interruption device including first and second terminal members, each terminal member having at least first and second through apertures and a terminal portion. The first and second through apertures of each terminal member are arranged spaced from each other and in a predetermined pattern. Also included is a plurality of pin structures, one pin structure for each pair of through apertures, where one pin structure is secured in the first through apertures of the respective first and second terminal members and another pin structure is secured in the second through apertures of the respective first and second terminal members. Such securing results in the first and second terminal members being maintained in fixed relation. Such a device is located within a housing so that the terminal portions extend outwardly from a housing end surface.

The present invention generally relates to automotive circuit breakers and more particularly to an automotive circuit breaker with integrated secondary current protection.

### BACKGROUND OF THE INVENTION

Electrical circuits for automotive, small engine, recreational vehicle and marine applications are protected from overload conditions (e.g., short-circuit) using any of a number of techniques known to those skilled in the art including the use of fuses, circuit breakers or a combination of both. A fuse is a one-time device that fuses or opens a link when the operating conditions are at or exceeding a pre-set parameter usually a current value. If the link is fused or opened, the fuse must be replaced by another fuse, which usually entails removing the opened fuse from the fuse block and inserting a replacement fuse of the same capacity. Needless to say, until the fuse is replaced, the particular circuit is inoperable. Before replacement of the fuse, it also is necessary for a user or repairperson to resolve the overload condition that caused the fuse to open/fuse.

As indicated above, the automotive electrical circuit also could be protected by a circuit breaker which is an automatically operated switch that is designed to protect an electrical circuit from damage that might be caused by an overload or short circuit. Such circuit breakers also can be designed to remain operable during the occurrence of a short-term overload/over current condition. Its basic function is to detect a fault condition and interrupt current flow to the circuit.

Unlike a fuse, which operates once and thus must be replaced; a circuit breaker is usually configured so it can be re-set to resume normal operations. In the case of automotive circuit breakers, the circuit breakers are generally broken down or categorized into three types; Type 1—the circuit breaker can reset automatically, Type-2, the circuit breaker re-sets remotely after power is removed (e.g., automobile power turned off and then back on) or Type 3—the circuit breaker is re-set manually. After the breaker is reset electrical power can be applied to the related electrical circuit.

In the manual resetting case, contacts within the breaker are physically separated from each other to break the electrical connection and thus trip the breaker. These contacts are maintained in this state until the breaker is manually re-set. When re-setting the breaker, the required action(s) are taken that will allow the contacts to again come into physical and electrical contact with each other to re-establish current flow through the breaker. Thus, to manual re-set the breaker one typically has to access the breaker or functionality associated with the breaker and take some action that allows the separated contacts to come back into contact with each other. As illustration, an insulated material is removably disposed between the contacts keeping them apart; and to re-set the breaker, the insulated material is removed from between the contacts and the contacts are thus put into a pre-trip condition.

Current automotive circuit breakers or breaker technology have been found by the industry to exhibit undesirable end-of life (EOL) failure modes. More specifically, such EOL failures have been found to affect the reliability of the circuit breaker to achieve an open circuit condition at EOL. In other words, such EOL failures affect the reliability of the breaker to trip or create an open circuit when there is an overload or overcurrent condition at or about EOL.

In addition, current automotive circuit breakers use an insert molding process that creates a rigid structure to keep the terminals of the circuit breaker in a desired orientation. This insert molding process also provides the insulation between the terminals or terminal plates. In addition, any testing of the circuit breaker must await the completion of the insert molding process. As the insert molding process is an expensive process and as any manufacturing or part failures are not detectable until after the insert molding process, this makes such failures costly.

It thus would be desirable to provide a new circuit breaker for automotive applications. It would be particularly desirable to provide such a new circuit breaker that would increase the reliability of the circuit breaker to achieve a better EOL open circuit condition in comparison to that for prior art or conventional automotive circuit breakers. It also would be desirable to provide such a circuit breaker that would be less costly to make as compared to prior art circuit breakers. Such a new circuit breaker also preferably would allow for reliable dimensional calibration. Further such circuit breakers preferably would not require the use of highly skilled users to replace and install such circuit breakers or require major modification of the electrical structures or components to which such breakers would be mounted for use.

### SUMMARY OF THE INVENTION

The present invention features a device; an assembly and/or apparatus that are particularly configured for controllably interrupting the current flow in such a device, assembly or apparatus and so as to also thereby interrupt the current flow in circuits configured with or including such a device, assembly or apparatus. Also featured is a method for making such a device/apparatus as well as a method for protecting electrical circuits from one or both of undesirable over current or over temperature conditions.

According to one aspect of the present invention, there is featured a circuit interruption assembly for controllably interrupting the flow of current responsive to the detection of an out of normal operational condition. Such an assembly includes a first terminal member and a second terminal member, each of the terminal members is configured with at least a first and a second through aperture and a terminal portion, wherein the first and second through apertures of each terminal member are arranged so as to spaced from each other and arranged in a predetermined pattern. Such an assembly also includes a plurality of pin structures, one pin structure for each pair of through apertures, where one pin structure or pin member is secured in the first through apertures of the respective first and second terminal members and another pin structure or pin member is secured in the second through apertures of the respective first and second terminal members. As a result of such securing, the first and second terminal members are maintained in fixed relation with respect to each other and in a desired orientation.

Such an assembly also includes a first circuit protection mechanism that is electrically coupled to the first and second terminal members. In more specific embodiments, the first circuit protection mechanism is arranged so as to be located inline electrically with the first and second terminal members. Such a first protection mechanism also is configured so as to cause at least a temporary interruption to the current flow between the first and second terminals responsive to at least one or both of over-current or over-temperature preset fault conditions.

In further embodiments, such an assembly further includes a secondary circuit protection mechanism that also is electrically coupled to the first and second terminals. In more specific embodiments, the secondary circuit protection mechanism is arranged so as to be located inline electrically with the first and second terminal members. The secondary protection mechanism also is configured for interrupting current flow between the first and second terminals responsive to another pre-set over-current fault condition. In more particular embodiments, such a secondary protection mechanism is a fuse link. Such a secondary protection mechanism is advantageous as it increases the reliability of the assembly to appropriately trip the breaker and create an open circuit condition at end-of-life for the circuit breaker assembly.

In yet further embodiments, such a circuit interruption assembly is configured and arranged so that the first and secondary protection mechanism are different from each other.

In yet further embodiments, such an assembly also can be configured so as to embody of any of the hereinafter described features including disposing the circuit interrupting assembly in a housing that is not formed integral with the assembly such as that which occurs when using the conventional insert molding process.

According to another aspect of the present invention, there is featured a circuit interruption device for controllably interrupting the flow of current responsive to the detection of an out of normal operational condition. Such an interruption device includes a first and a second terminal member, each of the terminal members being configured with at least a first and a second through aperture and a terminal portion. Also, the first and second through apertures of each terminal member are arranged so as to spaced from each other and arranged in a predetermined pattern.

Such an interruption device also includes a plurality of pin structures, one pin structure for each pair of through apertures. In addition, one pin structure is secured in the first through apertures of the respective first and second terminal members and another pin structure is secured in the second through apertures of the respective first and second terminal members, whereby such securing results in the first and second terminal members being maintained in fixed relation with respect to each other.

In further embodiments, each of the pin like structures has a predetermined length the first and second members are maintained a predetermined distance apart from each other when the pin like structures are secured in the first and second through apertures. Such a pin or pin like structure is composed of a ceramic material or alternatively, one of a dielectric material or an insulating material. The mechanical properties of such a material also are such as to maintain the terminal a predetermined distance apart when subjected to design loadings.

In yet further embodiments, each aperture is configured so that the pin engages the through aperture (e.g., mechanically) when inserted therein, thereby securing each of the first and second terminals to the pins and in fixed relation to each other. In more specific embodiments, each through aperture and each pin are respectively configured and dimensioned so as to establish a press-fit between the through aperture and end portions of the pin structure.

In yet further embodiments, such a circuit interruption device further includes a first protection mechanism or a tripping mechanism to detect an out-of-normal operational condition and to temporarily cut off or terminate current flow through the first and second terminals. This correspondingly interrupts the current flow in the electrical circuit(s) that is/are electrically coupled to the current interruption device. In further embodiments, such a tripping mechanism is configured so as to maintain the circuit interruption device in the tripped condition, cutting off current flow, until actions are taken to allow current flow to be re-established.

In further embodiments, such a tripping means or mechanism further includes a mechanism or means to re-establish the flow of current through the first and second terminals under pre-established conditions.

In more particular embodiments, the tripping means or mechanism includes a circuit component that is configured to maintain the open circuit condition of the first and second terminal members following detection of the out-of-normal condition and the circuit component also is responsive to an external signal to terminate its functionality. In more specific embodiments, the external signal includes the termination of electrical power to the circuit component and where current through the first and second terminals is re-established following restoration of power to the circuit component.

In yet further embodiments, the tripping means or mechanism includes a bimetallic circuit component that is configured to establish a closed circuit between the first and second terminals during normal operation and to establish an open circuit between the first and second terminal members during an out-of-normal condition when the bimetallic component is considered to be in an open condition.

Also, the circuit component further includes a positive temperature coefficient (PTC) device that is configured and arranged so as to maintain the bimetallic component in the open condition following device tripping. In more particular embodiments, the PTC device receives a small current that acts on (e.g., heats) the bimetallic component so as to maintain the bimetallic component at or above a desired temperature thereby maintaining the open circuit condition between the first and second terminal members.

In yet further embodiments such a circuit interruption device further includes a secondary circuit protection device, the secondary protection device including a fuse link or the like that is arranged so as to be in-line electrically with the first and second terminal members. Such a fuse link is configured to fuse at or above a pre-set current so as to cut off flow of current through the first and second terminal members. As indicated herein, such a secondary protection device advantageously provides a redundant mechanism for establishing an open circuit between the first and second terminal members particularly for end-of-life conditions.

In yet further embodiments, such a circuit interruption device further includes a bi-metallic element and a fuse link. The bi-metallic element is more particularly configured and arranged so it responds to a low overload out of normal operational condition and thereby cause the current flow through the terminal members to be temporarily interrupted. Such a bi-metallic element also is responsive to an over-temperature condition as well. The fuse link is arranged so it is in-line electrically with the first and second terminal members and the fuse link also is configured so as to fuse at or above a pre-set current corresponding to a high overload, so as to thereby permanently cut off flow of current through the first and second terminal members. In other words, an open circuit condition between the first and second terminal members is established requiring replacement of the interruption device in order to re-establish a closed electrical connection. In more specific embodiments, the bi-metallic element is configured so as to automatically re-set itself, one of after a predetermined time delay or after a change in state of the interruption device.

In yet further embodiments, the first and second terminal members are configured and arranged such that when the first and second terminal members are secured to the pin structures, the terminal end portions of the respective first and second terminal members are arranged so as to be spaced a predetermined distance from each other and so the terminal end portions essentially lie in the same plane. In this way, the terminal end portions can be inserted into the complimentary receptacles provided in a terminal box or the like.

According to another aspect of the present invention there is featured a circuit interruption apparatus that includes a circuit breaker assembly and a housing in which is disposed/received portions of the circuit breaker assembly. Such a circuit breaker assembly is configured so as to controllably interrupt the flow of current responsive to the detection of an out of normal operational condition.

Such a circuit breaker assembly includes a first terminal member and a second terminal member, each of the terminal members being configured with at least a first and a second through aperture and a terminal portion, where the first and second through apertures of each terminal member are arranged so as to be spaced from each other and arranged in a predetermined pattern. Such an assembly also includes a plurality of pin structures or pin like members, one pin structure for each pair of through apertures. Also, one pin structure is secured in the first through apertures of the respective first and second terminal members and another pin structure is secured in the second through apertures of the respective first and second terminal members, whereby such securing results in the first and second terminal members being maintained in fixed relation with respect to each other.

In yet further embodiments, each of the pin like structures has a predetermined length so as to maintain the first and second members a predetermined distance apart from each other when secured in the first and second through apertures. Also, each of the pins or pin like structures is composed of one of a ceramic material, a dielectric material or an insulating material.

In yet further embodiments, the first and second terminal members are configured and arranged such that when the first and second terminal members are secured to the pin structures, the terminal end portions of the respective first and second terminal members are arranged so as to be spaced a predetermined distance from each other and so the terminal end portions essentially lie in the same plane. In this way, the terminal end portions can be inserted to the receptacles provided for in the terminal box or the like for a circuit breaker or circuit interruption device.

In yet further embodiments, each aperture is configured so that the pin structure engages the through aperture (e.g., mechanically) when inserted therein, thereby securing the pin structure to the respective through aperture. In this way, each of the first and second terminal members is secured to the pins and in fixed relation to each other. In more specific embodiments, each through aperture and each pin are respectively configured so as to establish a press-fit type of connection between the through aperture and end portions of the pin structure.

In yet further embodiments, such a circuit interruption apparatus further includes a first tripping mechanism or tripping means for detecting an out-of-normal operational condition and for temporarily cutting off current flow through the first and second terminal members. Also, the tripping means/mechanism further includes a mechanism or means for re-establishing flow of current through the first and second terminal members under pre-established conditions. In addition, such a tripping means/mechanism includes a circuit component that is configured to maintain the open circuit condition of the first and second terminals following detection of the out-of-normal condition. Also, for such a circuit interrupting apparatus terminating electrical power to the circuit component terminates functionality of the circuit component; and current flow through the terminals is re-established following restoration of power to the circuit interruption apparatus.

In yet further embodiments, the tripping means/mechanism includes a bimetallic circuit component that is configured to establish a closed circuit between the first and second terminal members during normal operation and to establish an open circuit in at least one of the first and second terminal members during an out-of-normal condition when the bimetallic component is considered in an open condition. In additional embodiments, the circuit component includes a positive temperature coefficient device that maintains the bimetallic component in the open condition following device tripping.

In yet further embodiments, such a circuit interruption apparatus further includes a secondary circuit protection device, the secondary circuit protection device comprising a fuse link that is arranged so as to be in-line electrically with the first and second terminals. More specifically, the fuse link is arranged in-line electrically in one of the first or second terminal member. Such a fuse link is configured to fuse at or above a pre-set current so as to cut off flow of current through the first and second terminal members.

In yet further embodiments, such a circuit interruption apparatus further includes a bi-metallic element that responds to one of a low overload or over temperature out-of-normal operational condition and causes the current flow through the first and second terminals to be temporarily interrupted. Also included is a fuse link that is arranged so as to be in-line electrically with the first and second terminals, the fuse link being designed to fuse at or above a pre-set current corresponding to a high overload, so as to permanently cut off flow of current through the first and second terminal members. In additional embodiments, the current flow corresponding to the low overload operational condition is different (e.g., lower) that the current flow corresponding to the high overload operational condition.

In yet further embodiments, the housing and the first and second terminal members are configured and arranged so that the terminal end portions of the respective first and second terminal members extend outwardly (e.g., a predetermined distance) from a bottom end of the housing. Such a housing further includes an open end, located opposite to the housing bottom end, through which the circuit breaker assembly or circuit interruption device passes. The housing bottom end includes two through apertures through which pass the respective terminal end portions for the first and second terminal members. Also, the housing further includes four sides and a sealing member, the sealing member being securely disposed in the open end, where the four sides are joined to each of the sealing member and the bottom so as to form an enclosure.

In yet further embodiments, the sealing member further include artifacts that identify a current value of the circuit breaker assembly as well as other device information for the circuit breaker assembly or device that is located within the housing.

In yet a further aspect of the present invention there is featured a method for making a circuit breaker device or assembly of the present invention. Such a method includes providing first and second terminal members that are each configured with at least a first and a second through aperture and a terminal portion. The first and second through apertures of each terminal member are arranged so as to be spaced from each other and arranged in a predetermined pattern.

Also provided are a plurality of pin structures, one pin structure for each pair of through apertures.

Such a method further includes securing the first and second terminal members so as to be maintained in fixed relation with respect to each other. Such securing further includes securing one of the pin structures in the first through apertures of the respective first and second terminal members and securing another pin structure in the second through apertures of the respective first and second terminal members, whereby such securing results in the first and second terminal members being maintained in fixed relation with respect to each other.

Such providing also includes configuring the first and second terminals so as to include a first circuit protection mechanism that can be electrically coupled to the first and second terminal members. Such a first protection mechanism also is configured so as to cause at least a temporary interruption to current flow between the first and second terminal members responsive to at least one of an over-current or over-temperature preset fault conditions.

Such a method further includes configuring one of the first and second terminal members so as to further include a secondary circuit protection mechanism. The secondary protection mechanism is configured to interrupt current flow between the first and second terminals responsive to another pre-set over-current fault condition. In yet further embodiments, such a secondary protecting mechanism includes a fuse link that is arranged in-line electrically with the first and second terminal members.

In yet a further aspect of the present invention there is featured a method for protecting an electrical circuit from overload, over-current and/or over-temperature conditions such a method includes providing a circuit breaker assembly and electrically coupling the circuit breaker assembly in an electrical circuit so that the circuit breaker assembly can selectively interrupt current flow in the electrical circuit.

Such a circuit breaker assembly includes a first and a second terminal member, each of the terminal members being configured with at least a first and a second through aperture and a terminal portion, wherein the first and second through apertures of each terminal member are arranged so as to be spaced from each other and arranged in a predetermined pattern and a plurality of pin structures, one pin structure for each pair of through apertures. In such an assembly, one pin structure is secured in the first through apertures of the respective first and second terminal members and another pin structure is secured in the second through apertures of the respective first and second terminal members. As a result of such securing results in the first and second terminal members are maintained in fixed relation with respect to each other.

Such an assembly also includes a first circuit protection mechanism that is electrically coupled to the first and second terminal members. Such a first protection mechanism is configured so as to cause at least a temporary interruption to the current flow between the first and second terminal members responsive to at least one or both of over-current or over-temperature preset fault conditions.

In further embodiments, such an assembly further includes a secondary circuit protection mechanism that also is electrically coupled to the first and second terminals. The secondary protection mechanism is configured for interruption current flow in the first and second terminal members responsive to another pre-set over-current fault condition. In more particular embodiments, such a secondary protection mechanism is a fuse link. Such a secondary protection mechanism is advantageous as it increase the reliability of the assembly to appropriately trip the circuit and end-of-life for the assembly. In additional embodiments, the overcurrent condition for the first protection mechanism is different than the over current condition for the secondary protection mechanism.

In alternative embodiments, such a circuit breaker assembly includes a first and a second terminal member, each of the terminal members being configured with at least a first and a second through aperture and a terminal portion. Also, the first and second through apertures of each terminal member are arranged so as to be spaced from each other and arranged in a predetermined pattern.

Such a circuit breaker assembly also includes a plurality of pin structures, one pin structure for each pair of through apertures. In addition embodiments, one pin structure is secured in the first through apertures of the respective first and second terminal members and another pin structure is secured in the second through apertures of the respective first and second terminal members, whereby such securing results in the first and second terminal members being maintained in fixed relation with respect to each other. In more particular embodiments, the respective pin structures are mechanically engaged with the respective first and second through apertures. In more specific embodiments, a press fit is established between the respective pin structures and the respective first and second through apertures.

In further embodiments, each of the pin like structures has a predetermined length so as to maintain the first and second terminal members a predetermined distance apart from each other when the pin like structures are secured in the first and second through apertures. Such a pin or pin like structure is composed of a ceramic material or alternatively, one of a dielectric material or an insulating material.

Such an assembly also includes a first circuit protection mechanism that is electrically coupled to the first and second terminal members. Such a first protection mechanism is configured so as to cause at least a temporary interruption to the current flow in the first and second terminal members responsive to at least one or both of over-current or over-temperature preset fault conditions.

In further embodiments, such an assembly further includes a secondary circuit protection mechanism that also is electrically coupled to the first and second terminal members. The secondary protection mechanism is configured for interruption current flow between the first and second terminal members responsive to another pre-set over-current fault condition. In more particular embodiments, such a secondary protection mechanism is a fuse link. Such a secondary protection mechanism is advantageous as it increase the reliability of the assembly to appropriately trip the circuit and end-of-life for the assembly.

In yet further embodiments, such a circuit breaker assembly is configured and arranged so that the first and secondary protection mechanisms are different from each other. In additional embodiments, the overcurrent condition for the first protection mechanism is different than the over current condition for the secondary protection mechanism.

Other aspects and embodiments of the invention are discussed below.

### DEFINITIONS

The instant invention is most clearly understood with reference to the following definitions:

USP shall be understood to mean U.S. patent Number and U.S. Publication No. shall be understood to mean U.S. Published patent application Number.

The terms “comprising” and “including: as used in the discussion directed to the present invention and the claims are used in an open-ended fashion and thus should be interpreted to mean “including, but not limited to.” Also the terms “couple” or “couples” is intended to mean either an indirect or direct connection. Thus, if a first component is coupled to a second component, that connection may be through a direct connection, or through an indirect connection via other components, devices and connections. Further, the terms “axial” and “axially” generally mean along or substantially parallel to a central or longitudinal axis, while the terms “radial” and “radially” generally mean perpendicular to a central, longitudinal axis.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIGS. 1A-E are various views of circuit breakers or circuit interruption devices according to one aspect of the present invention without the cover for clarity; more particularly: a perspective view (FIG. 1A); a side view (FIG. 1B); a top view (FIG. 1C); another side view (FIG. 1D) and an end view (FIG. 1E).

FIGS. 2A-H are various views of circuit breakers or circuit interruption devices according to another aspect of the present invention without the cover for clarity; more particularly: a first perspective view (FIG. 2A); a side view (FIG. 2B); a top view (FIG. 2C); another side view (FIG. 2D); an end view (FIG. 2E); a second perspective view (FIG. 2F); a third perspective view showing a fuse link (FIG. 2G) and another top view also showing a fuse link (FIG. 2H).

FIGS. 3A-F are various views of circuit breakers or circuit interruption devices according to yet another aspect of the present invention without the cover for clarity; more particularly: a first perspective view (FIG. 3A); a side view (FIG. 3B); a top view (FIG. 3C); another side view (FIG. 3D); an end view (FIG. 3E) and a second perspective view (FIG. 3F).

FIGS. 4A-D are various views of a protective cover or enclosure for housing a circuit breaker or circuit interruption device according to the present invention including a front view (FIG. 4A), a side view (FIG. 4B), a top view with the sealing member detached and without the circuit breaker assembly for clarity (FIG. 4C) and a bottom view without the terminal end portions extending outwardly (FIG. 4D).

FIGS. 5A-D are various views of a protective cover or enclosure including a circuit breaker or circuit interruption device according to the present invention including a front view (FIG. 5A), a side view (FIG. 5B), a top view with the sealing member attached (FIG. 2C) and a bottom view with the terminal end portions extending outwardly (FIG. 5D).

### DESCRIPTION OF THE PREFERRED EMBODIMENT

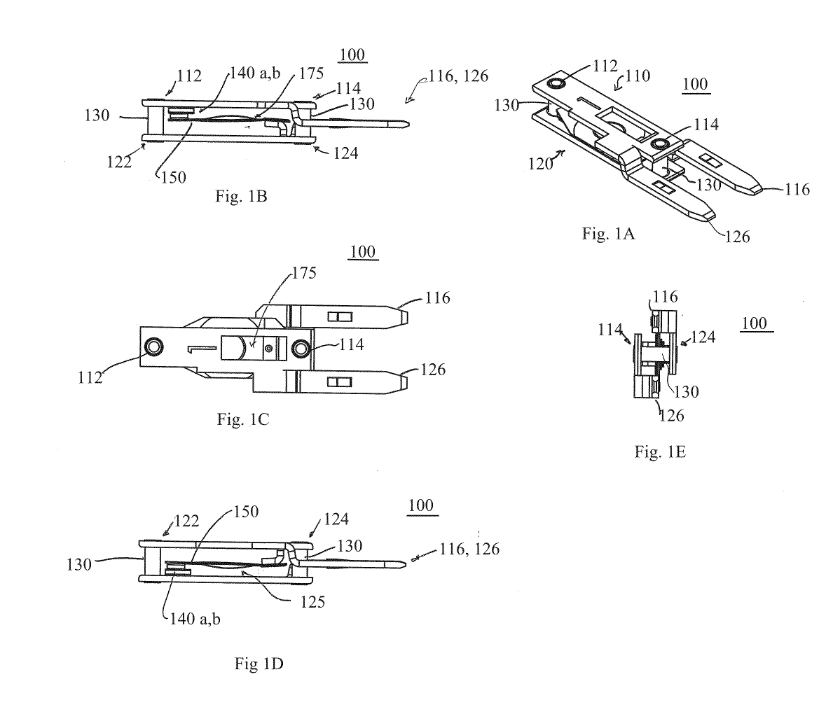

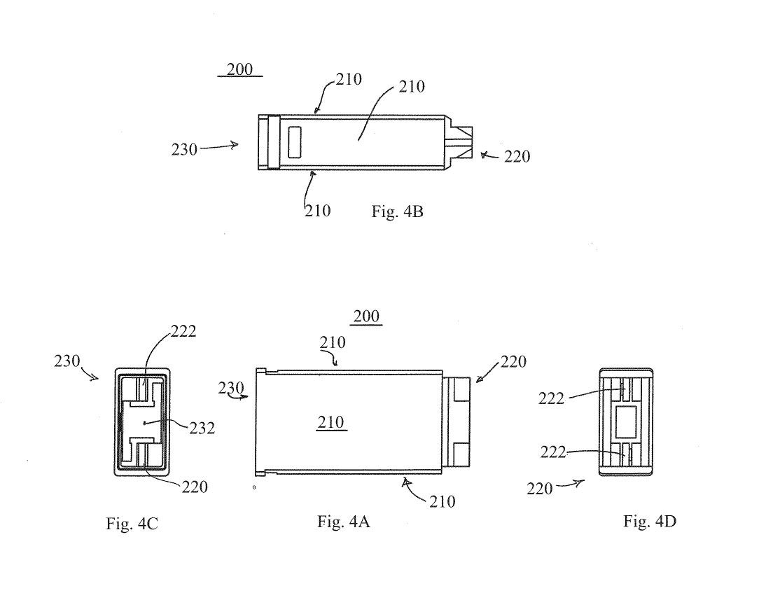

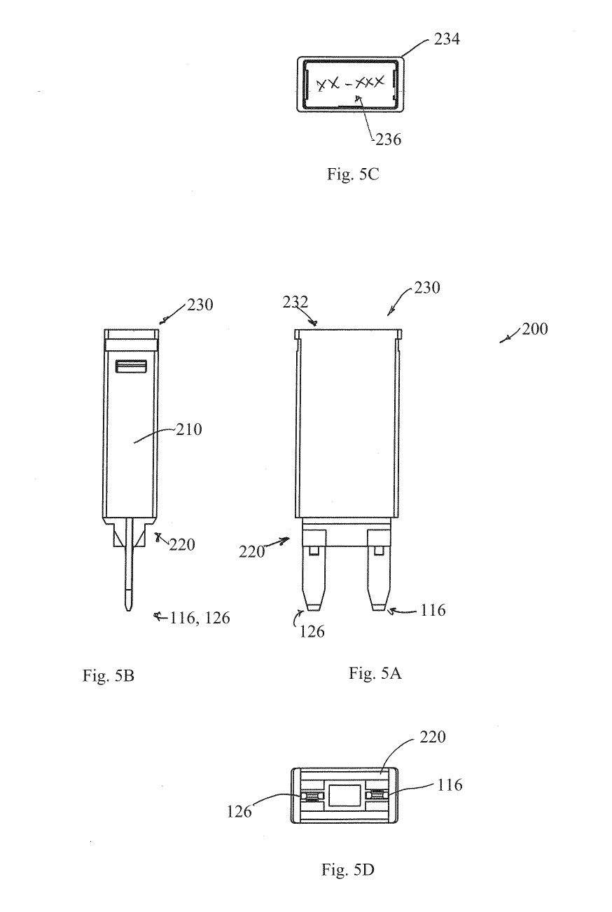

Referring now to the various figures of the drawing wherein like reference characters refer to like parts, there are shown in FIGS. 1A-E various views of a circuit breaker or circuit interruption device according to one aspect of the present invention without the cover for clarity; more particularly: a perspective view (FIG. 1A); a side view (FIG. 1B); a top view (FIG. 1C); another side view (FIG. 1D) and an end view (FIG. 1E). The illustrated circuit breaker or circuit interruption devices are what are termed Type I devices in that current flow is re-established in the associated circuit(s) after the breaker has re-set itself. Reference also should be made to FIGS. 4A-D which provide various views of a protective cover or enclosure for housing a circuit breaker or circuit interruption device according to the present invention and FIGS. 5A-D which provide various views of a protective cover or enclosure including a circuit breaker or circuit interruption device according to the present invention, both of which are discussed further herein. As indicated in those discussions, the circuit breakers or circuit protection devices of the present invention are housed in such protective cover or enclosure to protect the breaker/device from external effects as well as to protect a use or other person from coming into contact with the electrically energized breaker/device.

While reference is made to a circuit interruption device 100, 100b, 100c (FIGS. 1-3) in the following discussion, this shall not be considered as limiting the present invention in any way. Thus, the terms circuit breaker, circuit interruption device, circuit breaker assembly or circuit interruption assembly shall be understood as being used interchangeably and as referring to the electrical structure or circuitry that controllably interrupts the flow of current passing through an external electrical circuit and the circuit interruption device of the present invention, responsive to the detection of an out of normal operational condition such as, for example, an over-current or over-temperature fault condition. In other words, the circuit interruption device 100, 100b, 100c of the present invention is configured an arranged so as to establish a closed circuit where current can flow through the device and the external circuit during normal operation and which establishes an open circuit so that the external circuit is interrupted electrically and so the current flow in the external circuit also is interrupted under predetermined and preset conditions (e.g., when a predetermined current flow is exceeded). As described further herein, such a circuit interruption device 100, 100b, 100c also is configurable so as to embody two protection devices, a primary and a secondary protection device which are different from each other and which improve the circuit interruption device's ability to achieve an open circuit condition at or about the end-of-life for the device.

In more particular aspects/embodiments, the primary and secondary protection devices are so one of the protection devices at least causes a temporary interruption to the current flow between the first and second terminals responsive to at least one or both of over-current or over-temperature preset fault conditions and the other protection device is configured for interrupting current flow between the first and second terminals responsive to another pre-set over-current fault condition. Preferably the two over-current conditions of the two devices are different.

In one aspect of the present invention such a current interruption device 100 includes a first terminal member 110, a second terminal member 120 and a plurality of pins 130 or pin like structures that are used to mechanically couple or connect the first and second terminal members to each other. It should be noted that the use of the pin like structures 130 to mechanically couple or join the first and second terminal members 110, 120 so as to form a rigid structure deviates greatly from conventional or current automotive circuit breaker designs.

The first and second terminal members 110, 120 also are formed so as to include two through apertures 112, 114; 122, 124 in each of the first and second terminal member. The through apertures 112, 114; 122, 124 on each of the first and second terminal members are spaced from each other and arranged in a predetermined pattern. In this way, when one pin like structure 130 is secured in the first through apertures 112, 122 of the first and second terminal members 110, 120 and when the other pin like structure 130 is secured in the second through apertures 114, 124 of the first and second terminal members, a rigid structure is created. More particularly, the first and second terminal members are maintained in fixed relation with respect to each other when the respective pin like structures are mechanically coupled or connected to first and second terminal members.

The first and second terminal members 110, 120 also include a terminal end portion 116, 126 that are configured and arranged so that the end portions can be received in the receptacles of a fuse block or similar structure, which receptacles electrically couple the first and second terminal members to the desired electrical circuit. In more particular embodiments, the terminal end portions 116, 126 are configured and arranged such that when the first and second terminal members are secured in fixed relation with respect to each other by the pin like structures, the end terminal portions are spaced from each other and the end portions also are parallel to a predetermined plane. More specifically, the end portions lie in a common plane.

It should be recognized that while a plurality of pin like structures 130 and two pairs of through apertures 112, 114; 122, 124 are illustrated, this is not limiting. It is within the scope of the present invention for the first and second terminal members 110, 120 to include any number of pairs of through apertures and pin like structures (one pin like structure for each pair of through apertures) that can provide the desired structural rigidity for the first and second terminal members 110, 120 as well as dimensional stability for the terminal end portions 116, 126.

The first and second terminal members 110, 120 are constructed of any of a number of materials known in the art having electrical and strength characteristics sufficient for the intended use. Some exemplary materials include stainless steel and aluminum. The pin like structures 130 are any of a number of structures known in the art and acceptable for the intended use. In exemplary embodiments, the pin like structures are sold or hollow members having circular, oval, hexagonal, octagonal or other cross-sections which are made of ceramic, dielectric or insulating materials. The through apertures 112, 114; 122, 124 in which the pin like structures are received have a complementary cross-sectional shape such that when the pin like structure is received in the through aperture the pin like structure securely engages the through aperture so it is not movable (axially or rotationally) therein. In illustrative embodiments, a press fit or interference fit type of connection is formed between the pin like structure and the respective through aperture.

Joining of the first and second terminal members 110, 120 using the pin like structures 130 in effect replaces the insert molding process currently used in the manufacturing or making of conventional automotive circuit breakers. Such joining according to the present invention also advantageously provides a simplified assembly as compared to conventional circuit breakers, as well as allowing a simplified dimensional calibration and lower cost.

A first contact 140a is affixed or electrically coupled to the first terminal member 110 and a second contact 140b along with a bi-metallic element 150 is electrically coupled to the second terminal member. In particular embodiments, the two contacts 140a, b are electrically coupled to a distal portion of the respective first and second terminal members, the portion that is distal from the terminal end portions. During normal operation, the two contacts are urged into physical and electrical contact with each other such that current flows through the breaker and thus through the external electrical circuit. More specifically, the current would enter through one terminal member and pass through one of the contacts, thence pass through the bi-metallic element 150 (e.g., bi-metallic disc), and thence the second contact and thence out through the corresponding terminal.

In the illustrated embodiment, the second contact 140b is affixed to a portion of the bi-metallic element 150, which is urged by a spring element 175 so as to maintain the two contact in electrical contact with each other thereby allowing current to flow through the current interruption device. This shall not be limiting as it is within the scope of the present invention for the two contacts and the bi-metallic element to be arranged in any of a number of electrical configurations that can be arranged so as to have a similar electrical effect.

The snap acting bi-metallic element 150 is responsive to changing operational or electrical conditions. At or below a pre-determined current level (current levels associated with normal circuit and breaker operation the bi-metallic element remains in what is considered a closed condition. In the closed condition, the electrical contacts 140a, b remain in electrical and mechanical contact with each other thereby maintaining current flow through the breaker.

When a predetermined current level or above is reached, however, generally corresponding to an over-current or over-temperature faulted condition, the snap acting bi-metallic element reacts to the faulted condition and transitions into what is considered to an open condition. In the open condition, the constituents of the bi-metallic element move apart from each other a sufficient distance so as to cause the two contacts 140a, b to separate or move apart from each other and thereby interrupt the flow of current through the breaker and the related circuit and thereby also causing an open circuit.

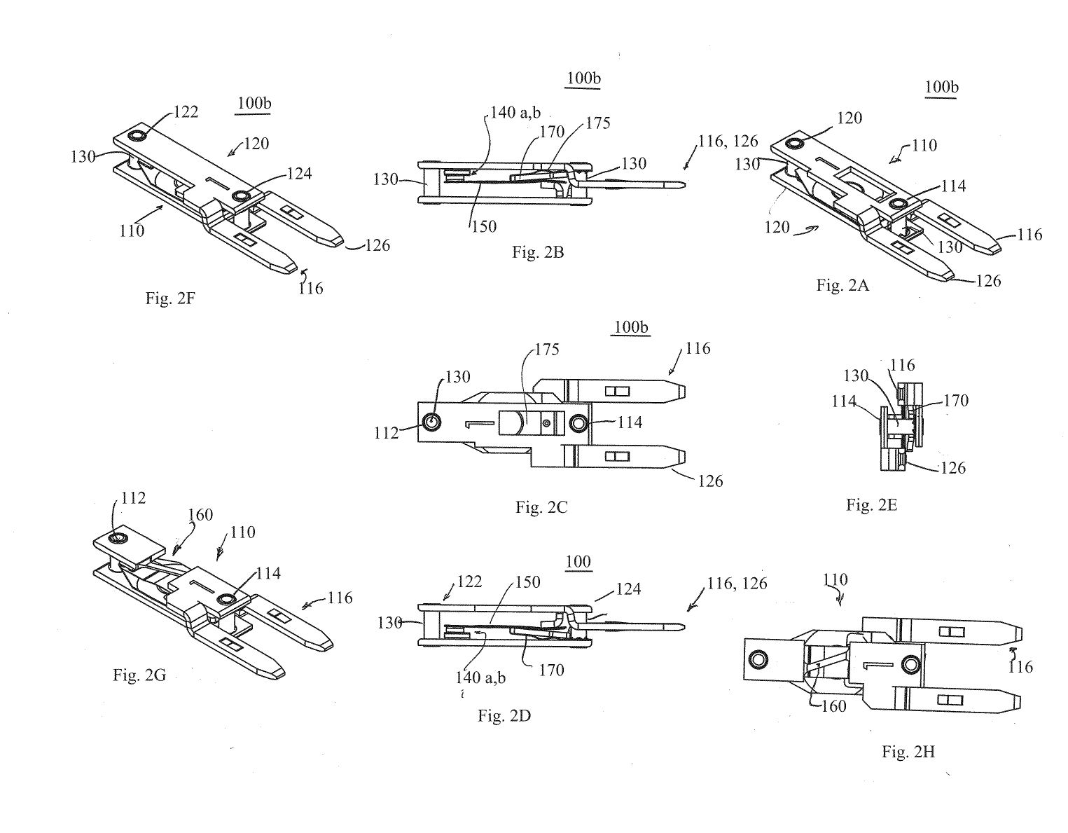

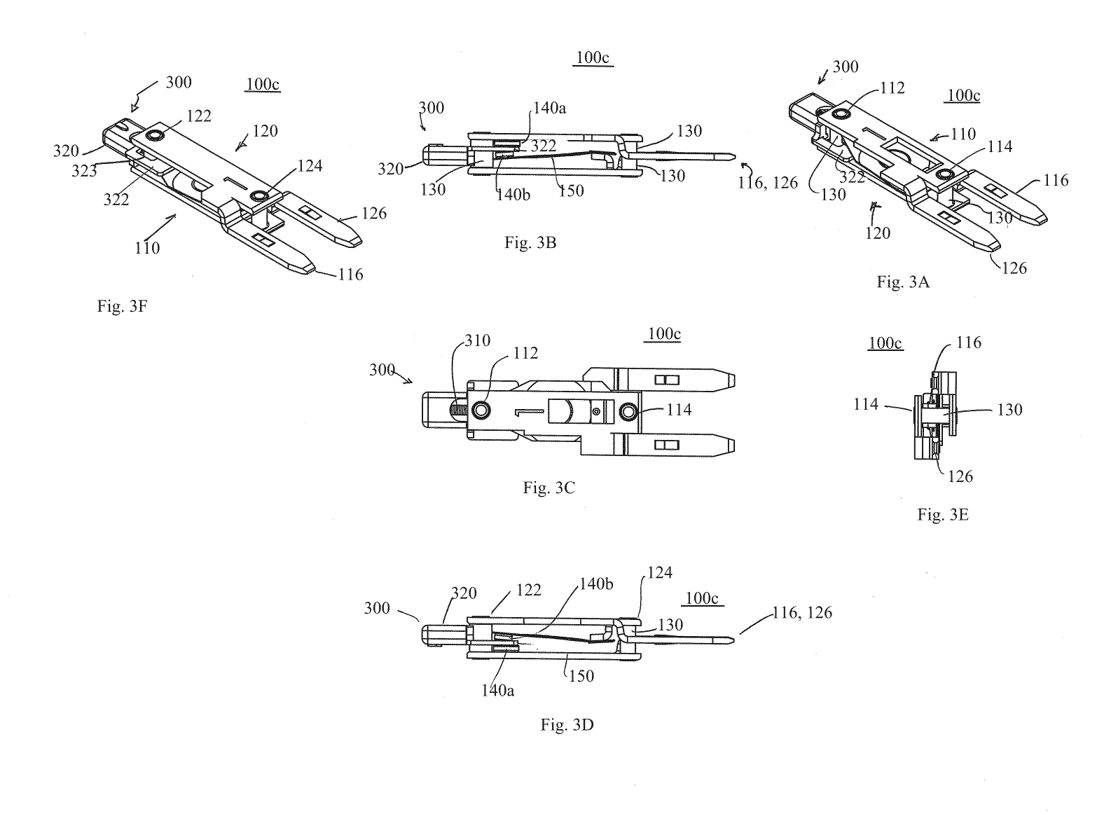

When the bi-metallic element returns back to the closed condition, the contacts 140a, b again come into mechanical and electrical contact with each other thereby allowing current to again flow through the circuit interruption device 1 as described herein. In this way, the circuit interruption device 100 automatically re-sets itself. If the out-of normal circuit conditions remain, however, the circuit interruption device 100 will again function as described herein to interrupt current flow. As discussed in connection with FIGS. 2 and 3, the Type 2 and 3 circuit interruption device are configured so as to maintain the circuit interruption device in the open condition until some action is taken to re-set the circuit interruption device. The discussion regarding these circuit interruptions follows.

The above-described bi-metallic element 150 in combination with the other structure of the circuit interruption device 100 forms one embodiment of a first protective mechanism or device according to the present invention. In more specific embodiments, the first protection mechanism is arranged so as to be located inline electrically with the first and second terminal members 110,120. Such a first protection mechanism also is configured so as to cause at least a temporary interruption to the current flow between the first and second terminals responsive to at least one or both of over-current or over-temperature preset fault conditions.

The first terminal member 110, more specifically a distal portion thereof, also is configurable so as to include a secondary circuit interruption mechanism or secondary protection mechanism or circuit element 160, such as that illustrated in FIGS. 2G and H, that is configured so as to continuously interrupt current flow between the first and second terminals responsive to an over-current or faulted current condition. In more particular embodiments, the secondary circuit interruption mechanism or secondary protection mechanism or circuit element 160 includes a circuit element such a fuse link (e.g., see FIGS. 2G and H) that fuses (e.g., forms an open circuit) when a significant overload current is applied to the circuit interruption device such as that which could occur if the external circuit had a short circuit. More particularly, the distal portion is arranged so as to include a structure that fuses when a significant overload current is applied to the circuit interruption device. More specifically, the first terminal member 110 is formed (e.g., stamped) so as to include a fusible link that extends between two segments 117a, b of the first terminal member.

Referring now to FIGS. 2A-H there are shown various views of a circuit breaker or circuit interruption device 100b according to another aspect or embodiment of the present invention without the cover or enclosure for clarity. More particularly there is shown, a first perspective view (FIG. 2A); a side view (FIG. 2B); a top view (FIG. 2C); another side view (FIG. 2D); an end view (FIG. 2E); a second perspective view (FIG. 2F); a third perspective view showing a fuse link (FIG. 2G) and another top view also showing a fuse link (FIG. 2H). The illustrated circuit breaker or circuit interruption device are what are termed Type II devices in that current flow is re-established in the associated circuit(s) after the breaker has been re-set by some signal. In the case of a Type II device, the breaker/device associated with the first protection device/mechanism, is typically reset by causing the electrical power to the affected circuit and/or device to be removed which allows the first protection mechanism or device breaker/device to re-set itself. Thereafter, power can be applied to re-energize the circuit.

As indicated above, reference also should be made to FIGS. 4A-D which provide various views of a protective cover or enclosure for housing a circuit breaker or circuit interruption device according to the present invention and FIGS. 5A-D which provide various views of a protective cover or enclosure including a circuit breaker or circuit interruption device according to the present invention, both of which are discussed further herein. In addition, reference also should be made to the foregoing discussion regarding FIGS. 1A-D for further details of this aspect/embodiment of the present invention, in particular for features having common reference numerals, unless otherwise described below. Reference also should be made to the discussion regarding FIGS. 1A-D as to the details regarding the secondary protection mechanism or circuit element 160 as shown in FIGS. 2G and H.

According to this aspect or embodiment of the present invention, the first circuit protection mechanism is further configured and arranged so that circuit interruption is maintained until the circuit interruption device 100b is remotely re-set such as by a remote signal. In particular embodiments, such re-setting is preferable achieved by an action of the operator or driver of the vehicle or a mechanic. More specifically, such re-setting is achieved by turning the electrical power of the vehicle off as described further herein.

In more particular embodiments, the circuit interruption device 100b includes a positive temperature coefficient (PTC) circuit element 170 and a spring element 175. The PTC circuit element 170 is arranged so as to be coupled to the bi-metallic element 150 and electrically coupled with the second terminal member 120. The PTC circuit element 170 also is coupled to the spring element 175 and the spring element is coupled to the second terminal member. In this way, when the bi-metallic element 150 cause the two contacts to separate, as described hereinabove, a current will still flow between the first and second terminal members 110, 120 and the PTC circuit element 170. This current flow heats up the PTC circuit element which in turn keeps the bi-metallic element heated so that it remains in the open condition. In this configuration, current is not flowing through the fuse link 160 because the contacts 140a,b are open, however, the current continues to pass through the PTC element albeit at a much lower current than that flowing under normal operating conditions.

When electrical power is removed from the circuit interruption device 100b, the PTC circuit element 170 will be de-energized. This in turn allows the bi-metallic element to cool down and also thereby allows the two contacts 140a, b to re-establish electrical and mechanical contact with each other. In other words, the circuit interruption device 100b becomes re-set. Thus, when electrical power is returned to the circuit interruption device 100b, electrical power (i.e., current and voltage) will be provided to the associate or related external circuit via the circuit interruption device and continued operation of the external circuit will thereafter be under control of the circuit interruption device as herein describe.

Referring now to FIGS. 3A-F there are shown various views of a circuit breaker or circuit interruption device 100c according to yet another aspect or embodiment of the present invention without the cover for clarity. More particularly there is shown, a first perspective view (FIG. 3A); a side view (FIG. 3B); a top view (FIG. 3C); another side view (FIG. 3D); an end view (FIG. 3E) and a second perspective view (FIG. 3F). The illustrated circuit breaker or circuit interruption device 100c are what are termed Type III devices in that current flow is re-established in the associated circuit(s) after the breaker has been manually re-set. In the case of a Type III device, the contacts are physically separated by some mechanism which can be removed only by manual action of a person such as the vehicle operator or mechanic. Such manual action causes the breaker/device 100b to be reset so that electrical power can thereafter be applied to re-energize the circuit. As indicated above, reference also should be made to FIGS. 4A-D which provide various views of a protective cover or enclosure for housing a circuit breaker or circuit interruption device according to the present invention and FIGS. 5A-D which provide various views of a protective cover or enclosure including a circuit breaker or circuit interruption device according to the present invention, both of which are discussed further herein. In addition, reference also should be made to the foregoing discussion regarding FIGS. 1A-D and FIGS. 2A-H for further details of this aspect/embodiment of the present invention, in particular for features having common reference numerals, unless otherwise described below. Reference also should be made to the discussion regarding FIGS. 1A-D as to the details regarding the secondary protection mechanism or circuit element 160 as shown in FIGS. 2G and H.

According to this aspect or embodiment of the present invention, the first circuit protection mechanism is further configured and arranged so as to include a manual actuation mechanism 300 that in turn is configured so that once the circuit interruption device 100c is actuated, circuit interruption by the first protection device circuit is physically maintained until the manual actuation device is manually thereby allowing the circuit interruption device 100c to be reset. As indicated herein, such manual re-setting of the manual activation device and the circuit interruption device 100c is accomplished by action of the operator or driver of the vehicle or a mechanic.

In the manual resetting case, the contacts 140a, b are physically separated from each other as herein described in connection with FIGS. 1-2 and are thereafter physically maintained in this open state by the manual actuation mechanism 300.

In exemplary embodiments, such a manual actuation device includes an insulated member deployment mechanism 310 including an insulating member and a means for causing the insulating member to be deployed. In a specific exemplary embodiment, the deployment means is a spring that acts of the insulating member such that when then structure inhibiting movement of the insulating member is removed the spring moves the insulating member so that is maintains the contacts 140a, b physically separated. More particularly, along with the tripping of the circuit interruption device 100c including the opening of the contacts 140a, b the insulated member is moved by the spring so the insulated member is disposed between the contacts thereby maintaining the contacts in the open position. In this way, the insulated member 300 also maintains the contacts electrically isolated from each other.

In yet further embodiments, the manual actuation member 300 includes a housing 320 having an extension portion 322. The extension portion 322 is preferably arranged so as to include an aperture 323 that extends about the pin like structure 130 proximal the manual actuation member 300 and about the contacts 140a, b whether in the closed or open condition. This extension structure has the beneficial effect of maintaining the alignment of the manual actuation member 300 with respect to the contacts 140a, b whether closed or opened.

To re-set the circuit interruption device 100c, the vehicle operator or mechanic takes the required action(s) with respect to the manual actuation device 300 that will allow the contacts 140a, b to again come into physical and electrical contact with each other and to re-establish current flow through the breaker. Thus, to manual re-set the breaker the operator or mechanic has to access the circuit interruption device or functionality associated therewith and then take some action that allows the separated contacts to come back into contact with each other. In the illustrated embodiment, the insulated member of the manual actuation device 300 is removably disposed between the contacts 140a, b thereby keeping them physically apart. In this case, the operator or mechanic manipulates the manual actuation device in the appropriate manner so as to withdraw the insulated member from between the contacts and into the manual actuation device 300 so the insulated member is returned to the pre-trip condition (e.g., spring mechanism is compressed). In this way, the circuit interruption device 100c is reset, thereby allowing to current to again flow through circuit interruption device and the related electrical circuit(s).

Referring now to FIGS. 4A-D and FIGS. 5A-d, there are shown various views of a protective cover 200 or enclosure without a circuit breaker assembly 100, 100b, 100c (FIGS. 1-3) of the present invention (FIGS. 4a-D) and with a circuit breaker assembly of the present invention (FIGS. 5A-D). More specifically, there is shown a front view of such a protective cover or enclosure for housing a circuit breaker or circuit interruption device according to the present invention (FIG. 4A), a side view (FIG. 4B), a top view with the sealing member detached and without the circuit breaker assembly for clarity (FIG. 4C) and a bottom view without the terminal end portions extending outwardly (FIG. 4D). Also, more specifically there is shown a front view of a protective cover or enclosure including a circuit breaker or circuit interruption device according to the present invention (FIG. 5A), a side view (FIG. 5B), a top view with the sealing member attached (FIG. 2C) and a bottom view with the terminal end portions extending outwardly (FIG. 5D). Reference also shall be made to the above discussion for FIGS. 1-3 for details of any features of the circuit breaker or circuit interruption device shown in any of these figures.

As shown such a protective cover 200 includes four sides 210, a bottom end 220 and a top end 230 having an opening 232 therein. Such a protective cover 200, enclosure or housing also is a separate from the circuit interruption device 100 herein described and is not formed integral with the circuit interruption device. This is in contrast to conventional automotive circuit breakers where the outer covering is formed using a conventional insert molding process, which makes the outer covering integral with the circuitry and structure of the breaker functionalities.

In further embodiments, the protective cover 200 and the first and second terminal members 110, 120 are configured and arranged so that the terminal end portions 116, 126 of the respective first and second terminal members extend outwardly (e.g., a predetermined distance) from a bottom end 220 of the protective cover. Such a protective cover 200 further includes an open end 232 in the top end 230, located opposite to the bottom end 220. In this way, the circuit breaker assembly or circuit interruption device 100 can be inserted through the open end 232 so that assembly or device, more particularly, the first and secondary protective mechanisms, are disposed within the protective cover 200, housing or enclosure.

The bottom end 220 also is configured so as to include two through apertures 222 through which pass the terminal end portions 116, 126 of the respective first and second terminal members and so that the terminal end portions extend outwardly from the protective cover as herein described and shown. In this way, the terminal end portions 116, 126 of the enclosed circuit interruption device can be inserted or plugged into the block terminal or receptacle in the terminal block assembly or fuse block assembly of the vehicle for the particular circuit being protected.

After the circuit interruption device is completely passed through the open end 232 and the terminal end portions properly positioned in the through apertures 222 in the bottom end (i.e., the circuit interruption device is otherwise disposed within the volume defined by the protective cover), the sealing member 234 is inserted into the open end and is sealingly engaged with the sides 210 and/or open end 232 of the top end 230 so that the protective cover encloses the circuit interruption device.

In yet further embodiments, the sealing member 234 further include artifacts 236 that provide identifying information regarding the circuit interruption device. For example, such identifying information includes a current value of the circuit breaker assembly as well as other device information for circuit breaker assembly or device that is located within the housing. In further embodiments, the sealing member is colored according to a predetermined scheme that also provides a redundant visual indication of certain identifying information (e.g., current rating of the circuit interruption device.

Such a protective cover 200 including the sealing member are made from any of a number of materials that are appropriate for the intended use including the expected environmental conditions. In exemplary embodiments, the part of the protective cover including the sides 210, the open end 232 and the bottom end 220 is a plastic material such as a thermoset type of plastic and the sealing member 234 is a plastic snap cover, more specifically a thermoplastic snap cover. More particularly, such a sealing member 234 is mechanically engaged with the top end 230 using any of a number of techniques known in the art to secure and to seal the sealing member to the protective cover. Such sealing is intended to prevent quantities of a material (e.g., conductive fluid, water) from gaining access to the interior volume that could affect the operability and functionality of the circuit interruption device/circuit breaker therein.

In yet further embodiments, the protective cover, enclosure or housing and the first and second terminal members are configured and arranged so that the terminal end portions 116, 126 of the respective first and second terminal members extend outwardly (e.g., a predetermined distance) from a bottom end of the housing. Such a housing further includes an open end, located opposite to the housing bottom end, through which the circuit breaker assembly or circuit interruption device passes. The housing bottom end includes two through apertures through which pass the respective terminal end portions for the first and second terminal members. Also, the housing further includes four sides and a sealing member, the sealing member being securely disposed in the open end, where the four sides are joined to each of the sealing member and the bottom so as to form an enclosure.

In yet further embodiments, the sealing member further include artifacts (e.g., visual indicia) that identify a current value of the circuit breaker assembly as well as other device information for circuit breaker assembly or device that is located within the housing.

In contrast to conventional automotive circuit breakers made using the conventional insertion molding process, the circuit protection device 100 is completely assembled in its final form before it is inserted into the protective cover 200 as described herein and sealed therein by closing the open end 232 using the snap cover or sealing member 234. As the process does not involve the costly insertion molding process the circuit interruption device of the present invention is less costly.

In yet a further aspect, there is featured a method for making a circuit interruption device 100 or assembly including a protective cover 200 of the present invention. Reference shall be made to FIGS. 1-5 and the related discussion for details of the structure of such a device and protective cover.

Such a method includes providing first and second terminal members 110, 120 that are each configured with at least a first and a second through apertures 112, 114; 122, 124 and a terminal end portion 116, 126. Also, such a method includes arranging the first and second through apertures 112, 114; 122, 124 of the respective terminal member 110, 120 so as to be spaced from each other and so as to be arranged in a predetermined pattern. Such providing also includes providing a plurality of pin structures, one pin structure for each pair of through apertures.

Such a method further includes securing the first and second terminal members 110, 120 to each other so as to be maintained in fixed relation with respect to each other. Such securing further includes securing one of the pin structures 130 in the first through apertures 112, 122 of the respective first and second terminal members and securing another pin structure 130 in the second through apertures 114, 124 of the respective first and second terminal members, whereby such securing results in the first and second terminal members being maintained in fixed relation with respect to each other.

Such providing also includes configuring the first and second terminal members 110, 120 so as to include a first circuit protection mechanism that is electrically coupled to the first and second terminal members. Such a first protection mechanism is configured so as to cause at least a temporary interruption to current flow between the first and second terminal members responsive to at least one of an over-current or over-temperature preset fault conditions. See discussion above regarding FIGS. 1-3 as to further details of such a first protection mechanism.

Such a method further includes configuring one of the first and second terminal members 110, 120 so as to further include a secondary circuit protection mechanism. The secondary protection mechanism is configured to interrupt (e.g., continuously interrupt) current flow between the first and second terminals responsive to another pre-set over-current fault condition. In yet further embodiments, such a secondary protecting mechanism includes a fuse link 160 that is arranged in-line electrically with the first and second terminal members. Reference also should be made to the discussion regarding FIGS. 1A-D as to the details regarding the secondary protection mechanism or circuit element 160 as shown in FIGS. 2G and H.

In yet a further aspect of the present invention there is featured a method for protecting an electrical circuit from overload, over-current and/or over-temperature conditions such a method includes providing a circuit breaker assembly or device 100 and electrically coupling the circuit breaker assembly or device in an electrical circuit so that the circuit breaker assembly or device can selectively interrupt current flow in the electrical circuit.

Such providing includes providing a circuit breaker assembly including a first and a second terminal member 110, 120, each of the terminal members being configured with at least a first and a second through aperture 112, 114; 122, 124 and a terminal end portion 116, 126, wherein the first and second through apertures of each terminal member are arranged so as to be spaced from each other and arranged in a predetermined pattern. Such a circuit breaker assembly also includes a plurality of pin structures 130, one pin structure for each pair of through apertures. In such an assembly, one pin structure is secured in the first through apertures 112, 122 of the respective first and second terminal members 110, 120 and another pin structure 130 is secured in the second through apertures 114, 124 of the respective first and second terminal members. As a result of such securing the first and second terminal members 110, 120 are maintained in fixed relation with respect to each other.

Such an assembly or device also includes a first circuit protection mechanism that is electrically coupled to the first and second terminal members. Such a first protection mechanism is configured so as to cause at least a temporary interruption to the current flow between the first and second terminal members responsive to at least one or both of over-current or over-temperature preset fault conditions.

In further embodiments, such an assembly further includes a secondary circuit protection mechanism that also is electrically coupled to the first and second terminals. The secondary protection mechanism is configured for interruption (e.g., continuous interruption) current flow in the first and second terminal members responsive to another pre-set over-current fault condition. In more particular embodiments, such a secondary protection mechanism is a fuse link 160. Such a secondary protection mechanism is advantageous as it increase the reliability of the assembly to appropriately trip the circuit and end-of-life for the assembly. Reference also should be made to the discussion regarding FIGS. 1A-D as to the details regarding the secondary protection mechanism or circuit element 160 as shown in FIGS. 2G and H.

In alternative embodiments, the provided circuit breaker assembly or device includes a first and a second terminal member 110, 120, each of the terminal members being configured with at least a first and a second through aperture 112, 114; 122, 124 and a terminal end portion 116, 126. Also, the first and second through apertures 114, 114; 122, 124 of each terminal member are arranged so as to be spaced from each other and arranged in a predetermined pattern.

Such a circuit breaker assembly or device also includes a plurality of pin structures 130, one-pin structure for each pair of through apertures. In addition, one pin structure 130 is secured in the first through apertures 112, 122 of the respective first and second terminal members and another pin structure 130 is secured in the second through apertures 114, 124 of the respective first and second terminal members 110, 120, whereby such securing results in the first and second terminal members being maintained in fixed relation with respect to each other.

In further embodiments, each of the pin like structures 130 has a predetermined length so as to maintain the first and second terminal members 110, 120 a predetermined distance apart from each other when the pin like structures are secured in the first and second through apertures 112, 114; 122; 124. Such a pin or pin like structure 130 is composed of a ceramic material or alternatively, one of a dielectric material or an insulating material. Reference shall be made to the discussion regarding FIGS. 1-3 as to further details of such securing and the pin or pin like structures.

Such an assembly or device also includes a first circuit protection mechanism that is electrically coupled to the first and second terminal members 110, 120. Such a first protection mechanism is configured so as to cause at least a temporary interruption to the current flow in the first and second terminal members responsive to at least one or both of over-current or over-temperature preset fault conditions. Reference shall be made to the discussion regarding FIGS. 1-3 as to further details of such a first protection mechanism.

In further embodiments, such an assembly further includes a secondary circuit protection mechanism that also is electrically coupled to the first and second terminal members 110, 120. The secondary protection mechanism is configured for interruption current flow between the first and second terminal members responsive to another pre-set over-current fault condition. In more particular embodiments, such a secondary protection mechanism is a fuse link 160. Such a secondary protection mechanism is advantageous as it increase the reliability of the assembly to appropriately trip the circuit and end-of-life for the assembly. Reference shall be made to the discussion regarding FIGS. 1-3 as to further details of such a secondary protection mechanism. More particularly, reference should be made to the discussion regarding FIGS. 1A-D as to the details regarding the secondary protection mechanism or circuit element 160 as shown in FIGS. 2G and H.

In yet further embodiments, such a circuit breaker assembly is configured and arranged so that the first and secondary protection mechanisms are different from each other.

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A circuit interruption device for controllably interrupting the flow of current responsive to the detection of an out of normal operational condition; said device comprising;
a first and a second terminal member, each of the terminal members being configured with at least a first and a second through aperture and a terminal portion;
wherein the first and second through apertures of each terminal member are arranged so as to be spaced from each other and arranged in a predetermined pattern;
a plurality of pin structures, one pin structure for each pair of through apertures; and
wherein one pin structure is secured in the first through apertures of the respective first and second terminal members and another pin structure is secured in the second through apertures of the respective first and second terminal members, whereby such securing results in the first and second terminal members are maintained in fixed relation with respect to each other.

2. The circuit interruption device of claim 1, wherein each of the pin like structures has a predetermined length so as to maintain the first and second members a predetermined distance apart from each other when secured in the first and second through apertures.

3. The circuit interruption device of claim 1, wherein the pin is composed of a ceramic material.

4. The circuit interruption device of claim 1, wherein the pin is composed of one of a dielectric material or an insulating material.

5. The circuit interruption device of claim 1, wherein each through aperture is configured so as to establish a press-fit between the through aperture and end portions of the pin structure.

6. The circuit interruption device of claim 1, further comprising a tripping means for detecting an out-of-normal operational condition and for temporarily cutting off current flow through the first and second terminals.

7. The circuit interruption device of claim 6, wherein said tripping means further includes means for re-establishing flow of current through the first and second terminals under pre-established conditions.

8. The circuit interruption device of claim 6, wherein said tripping means includes a circuit component that is configured to maintain the open circuit condition of the first and second terminals following detection of the out-of-normal condition and wherein said circuit component is responsive to an external signal to terminate its functionality.

9. The circuit interruption device of claim 8, wherein the external signal comprises termination of electrical power to the circuit component and wherein current flow through the terminals is continued following restoration of power to the circuit component.

10. The circuit interruption device of claim 8, wherein:
the tripping means includes a bimetallic circuit component that is configured to establish a closed circuit between the first and second terminals during normal operation and to establish open circuit between the first and second terminals during an out-of-normal condition when the bimetallic component is in an open condition; and
the circuit component is a positive temperature coefficient device that maintains the bimetallic component in the open condition following device tripping.

11. The circuit interruption device of claim 10, further comprising a secondary circuit protection device, the secondary protection device comprising a fuse link that is arranged so as to be in-line electrically between the first and second terminals, the fuse link being configured to fuse at or above a pre-set current so as to cut off flow of current through the first and second terminals.

12. The circuit interruption device of claim 1 further comprising:
a bi-metallic element that responds to a low overload out of normal operational condition and cause the current flow through the terminals to be temporarily interrupted; and
a fuse link that is arranged so as to be in-line electrically between the first and second terminals, the fuse link being designed to fuse at or above a pre-set current corresponding to a high overload, so as to permanently cut off flow of current through the first and second terminals.

13. The circuit interruption device of claim 12, wherein the bi-metallic element is configured so as to automatically re-set itself, one of after a predetermined time delay or after a change in state of the interruption device.

14. The circuit interruption device of claim 1, wherein the first and second terminal members are configured and arranged such that when the first and second terminal members are secured to the pin structures, terminal end portions of the respective first and second terminal members are arranged so as to be spaced a predetermined distance from each other and so the terminal end portions essentially lie in the same plane.

15. A circuit interruption apparatus comprising a circuit breaker assembly and a housing in which is received portions of the circuit breaker assembly;
wherein the circuit breaker assembly is configured so as to controllably interrupt the flow of current responsive to the detection of an out of normal operational condition; said circuit breaker assembly including:
a first and a second terminal member, each of the terminal members being configured with at least a first and a second through aperture and a terminal portion;
wherein the first and second through apertures of each terminal member are arranged so as to be spaced from each other and arranged in a predetermined pattern;
a plurality of pin structures, one pin structure for each pair of through apertures; and
wherein one pin structure is secured in the first through apertures of the respective first and second terminal members and another pin structure is secured in the second through apertures of the respective first and second terminal members, whereby such securing results in the first and second terminal members are maintained in fixed relation with respect to each other.

16. The circuit interruption apparatus of claim 15, wherein each of the pin like structures has a predetermined length so as to maintain the first and second members a predetermined distance apart from each other when secured in the first and second through apertures.

17. The circuit interruption apparatus of claim 15, wherein the pin is composed of one of a ceramic material, a dielectric material or an insulating material.

18. The circuit interruption apparatus of claim 15, wherein the first and second terminal members are configured and arranged such that when the first and second terminal members are secured to the pin structures, terminal end portions of the respective first and second terminal members are arranged so as to be spaced a predetermined distance from each other and so the terminal end portions essentially lie in the same plane.

19. The circuit interruption apparatus of claim 15, wherein each through aperture of the first and second terminals is configured so as to establish a press-fit between the through aperture and end portions of the pin structure.

20. The circuit interruption apparatus of claim 15, further comprising a tripping means for detecting an out-of-normal operational condition and for temporarily cutting off current flow through the first and second terminals and wherein said tripping means further includes means for re-establishing flow of current through the first and second terminals under pre-established conditions.

21. The circuit interruption apparatus of claim 20, wherein:
said tripping means includes a circuit component that is configured to maintain the open circuit condition of the first and second terminals following detection of the out-of-normal condition;
terminating electrical power to the circuit component terminates functionality of the circuit component; and
current flow through the terminals is re-established following restoration of power to the circuit interruption apparatus.

22. The circuit interruption apparatus of claim 20, wherein:
the tripping means includes a bimetallic circuit component that is configured to establish a closed circuit between the first and second terminals during normal operation and to establish an open circuit between the first and second terminals during an out-of-normal condition when the bimetallic component is considered in an open condition; and
the circuit component is a positive temperature coefficient device that maintains the bimetallic component in the open condition following device tripping.

23. The circuit interruption apparatus of claim 22, further comprising a secondary circuit protection device, the secondary protection device comprising a fuse link that is arranged so as to be in-line electrically between the first and second terminals, the fuse link being configured to fuse at or above a pre-set current so as to cut off flow of current through the first and second terminals.

24. The circuit interruption apparatus of claim 15, further comprising a fuse link that is arranged so as to be in-line electrically between the first and second terminals, the fuse link being designed to fuse at or above a pre-set current so as to cut off flow of current through the first and second terminals.

25. The circuit interruption apparatus of claim 15, further comprising:
a bi-metallic element that responds to one of a low overload or over temperature out-of-normal operational condition and causes the current flow through the first and second terminals to be temporarily interrupted; and
a fuse link that is arranged so as to be in-line electrically between the first and second terminals, the fuse link being designed to fuse at or above a pre-set current corresponding to a high overload, so as to permanently cut off flow of current through the first and second terminals.

26. The circuit interruption apparatus of claim 18, wherein the housing and the first and second terminal members are configured and arranged so that the terminal end portions of the respective first and second terminal members extend outwardly from a bottom end of the housing.

27. The circuit interruption apparatus of claim 26, wherein:
the housing further includes an open end through which the circuit breaker assembly passes;
the housing bottom end includes two through aperture through which pass the respective terminal end portions for the first and second terminal members;
the housing further includes four sides and a sealing member, the sealing member being securely disposed in the open end,
the four sides are joined to each of the sealing member and the bottom so as to form an enclosure.

28. The circuit interruption apparatus of claim 27, wherein the sealing member further include artifacts that identify a current value of the circuit breaker assembly located within the housing.

29. A circuit interruption assembly for controllably interrupting the flow of current responsive to the detection of an out of normal operational condition; said assembly comprising;
a first and a second terminal member, each of the terminal members being configured with at least a first and a second through aperture and a terminal portion, wherein the first and second through apertures of each terminal member are arranged so as to be spaced from each other and arranged in a predetermined pattern;
a plurality of pin structures, one pin structure for each pair of through apertures;
wherein one pin structure is secured in the first through apertures of the respective first and second terminal members and another pin structure is secured in the second through apertures of the respective first and second terminal members, whereby such securing results in the first and second terminal members are maintained in fixed relation with respect to each other; and
a first circuit protection mechanism being electrically coupled to the first and second terminals, the first protection mechanism being configured so as to cause at least a temporary interruption to current flow between the first and second terminals responsive to at least one of over-current or over-temperature preset fault conditions.

30. The circuit interruption assembly of 29, further comprising a secondary circuit protection mechanism being electrically coupled to the first and second terminals, the secondary protection mechanism being configured for interruption current flow between the first and second terminals responsive to another pre-set over-current fault condition.

31. The circuit interruption assembly of 30, wherein the first and secondary protection mechanism are different from each other.
